(19) United States
(12) Patent Application Publication
(10) Pub. No.: US 2010/0127203 A1
(43) Pub. Date: May 27, 2010

(54) INORGANIC FOAMS

(75) Inventors: Tatiana Ulanova, Ludwigshafen (DE); Armin Alteheld, Bad Kreuznach (DE); Klaus Hahn, Kirchheim (DE); Patrick Deck, Mannheim (DE); Meik Ranft, Bensheim-Hochstadten (DE); Frank Heilmann, Dirmstein (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/597,340

(22) PCT Filed: Apr. 23, 2008
(86) PCT No.: PCT/EP08/54919

§ 371 Date: Oct. 23, 2009

(30) Foreign Application Priority Data
Apr. 25, 2007 (EP) 07106945.4

(51) Int. Cl. E04B 1/74; C09K 13/00

(52) U.S. Cl. 252/62; 252/79.1

(57) ABSTRACT

A process for producing a silicate foam having a low density, which comprises the following steps:
(a) partial hydrolysis of an aqueous dispersion of SiO₂ particles which have an average particle diameter in the range from 1 to 100 nm by means of a strong base,
(b) addition of a surfactant and a blowing agent and dispersion of the blowing agent at temperatures below 50° C.,
(c) foaming of the mixture by heating to a temperature in the range from 35 to 100° C. or by depressurization,
(d) stabilization of the foam obtained in step c) by means of a hardener,
(e) sintering of the foam at a temperature above 500° C.

The invention relates to a process for producing a silicate foam and a silicate foam which can be obtained by the process.

Organic foams based on polystyrene, polyolefins or polyurethanes are frequently used for thermal and acoustic insulation. However, these are comparatively readily flammable and combustible without addition of flame retardant additives. Foams having an inorganic basis are by their very nature not readily flammable. However, they generally have a relatively high density and brittleness.

GB 986 635 describes a process for producing calcined alumina as filler for paper and plastics. Here, an aqueous slurry of the alumina is converted into a stable foam which is calcined and can subsequently be crumbled to give a fine powder.

U.S. Pat. No. 3,737,332 describes a closed-celled foam which has a high density and can be obtained by blowing air into an alumina slurry and subsequent drying and calcination at temperatures in the range from 540 to 1500° C. The closed-cell nature is achieved by stabilization of the alumina slurry by means of fatty acid amides.

DE-A 36 17 129 describes a process for filling hollow spaces with foam by mixing a silicate solution with a hardener and a component which produces gas by means of a chemical reaction, for example hydrogen peroxide. Mixing of the components and injection into the hollow space in situ gives a foam having a density in the range from 30 to 1000 kg/m³.

WO 03/018476 describes an elastic inorganic foam which has a density of less than 25 kg/m³ and is based on an aluminosilicate having a molar ratio of SiO₂:Al₂O₃ of from 20:1 to 1:1.

U.S. Pat. No. 4,221,578 relates to a porous amorphous silicate body which is essentially free of alkali metals and has a low thermal conductivity. The good insulating properties are achieved essentially by use of infrared-absorbing metal oxides. The alkali metal content is reduced by washing. This is said to improve the thermal stability of the silicate structure. No blowing agents are used for producing the porous silicate body. The densities of the shaped bodies in the examples are therefore about 25 lbs/ft³, which corresponds to a density of 400 kg per cubic meter.

EP-A 1 142 619 describes a ceramic filter having a sealing layer having a thickness of from 0.3 to 3 mm and a low thermal conductivity. The sealing layer comprises inorganic fibers, an inorganic binder and an organic binder and inorganic particles. The proportion of the colloidal silicate gel used as inorganic binder is from 1 to 30 percent by weight.

DE-A21 65 912 describes foams which are obtained by foaming aqueous silicate solutions in the presence of a blowing agent and a hardener which releases acid. The density of the water-free foams claimed is from 40 to 600 g/l.

GB-A1 430 875 describes inorganic foams which are produced by foaming aqueous alkali metal silicate or ammonium silicate solutions, in particular sodium silicates, by means of a blowing agent and a hardener which releases acid. The ratio of SiO₂:Na₂O is in the range from 1.6:1 to 3.4:1. The density of the foam mentioned in the example is 23 lb/ft³, which corresponds to more than 360 g/l.

EP-A 63 609 describes inorganic foams which are obtained from water-soluble silicates, a blowing agent system based on metal and a hardener system. Only water-soluble silicates are described as foamable. Colloidal dispersions are not mentioned. Numerous examples are given; the lowest density described is 200 g/l.

PCT/EP2006/067472, which is not a prior publication, describes a low-sodium silicate foam which has a density of less than 25 kg/m³ and a molar ratio of SiO₂:Al₂O₃ of greater than 20:1 and a molar ratio of SiO₂:Me₂O of greater than 50:1, where Me is an alkali metal, its use for thermal or acoustic insulation and also processes for its production by mixing a dispersion of SiO₂ particles having an average particle diameter in the range from 1 to 100 nm with a surfactant and a blowing agent at temperatures below 50° C. and foaming the mixture by heating to a temperature in the range from 60 to 100° C. or by depressurization.

Inorganic flexible foams having a low density are of interest for many applications because of their high thermal stability, noncombustibility and a low volatiles content. However, the processes proposed hitherto suffer from difficulties in the production and stabilization of the foam structures.

It was an object of the present invention to remedy the disadvantages mentioned and provide a process for producing a flexible inorganic foam having a low density which is not only noncombustible but also has good thermal and acoustic insulation properties.

We have accordingly found a process for producing a silicate foam, which comprises the following steps:

(a) partial hydrolysis of an aqueous dispersion of SiO₂ particles which have an average particle diameter in the range from 1 to 100 nm by means of a strong base,

(b) addition of a surfactant and a blowing agent and dispersion of the blowing agent at temperatures below 50° C.,

(c) foaming of the mixture by heating to a temperature in the range from 35 to 100° C. or by depressurization,

(d) stabilization of the foam obtained in step c) by means of a hardener,

(e) sintering of the foam at a temperature above 500° C.

The partial hydrolysis of the colloidal SiO₂ nanoparticles leads to improved foamability. Preference is given to using lithium, sodium, potassium, rubidium or cesium hydroxide for the partial hydrolysis of the aqueous dispersion of SiO₂ particles in step (a).

The alkali metal hydroxide is preferably added in such an amount that the partially hydrolyzed aqueous dispersion in step a) has a molar ratio of SiO₂:Me₂O of less than 50:1, preferably less than 20:1, in particular in the range from 10:1 to 1:1, where Me is an alkali metal. The alkali metal content leads to a life-dependent viscosity change and better film formation, so that temporary stabilization of the foam after foaming is simplified.

An aqueous, colloidal SiO₂ particle dispersion stabilized by onium ions, in particular ammonium ions such as NH₄⁺, as counterion is preferably used in step a). The average particle diameter of the SiO₂ particles is in the range from 1 to 100 nm, preferably in the range from 10 to 50 nm. The specific surface area of the SiO₂ particles is generally in the range from 10 to 3000 m²/g, preferably in the range from 30 to 1000 m²/g. The solids content of commercial SiO₂ particle dispersions depends on the particle size and is generally in the range from 10 to 60% by weight, preferably in the range from 30 to 50% by weight. Aqueous, colloidal SiO₂ particle dispersions can be obtained by neutralization of dilute sodium silicates with acids, ion exchange, hydrolysis of silicon compounds such as alkoxysilanes, dispersion of pyrogenic silicate or gel precipitation.

Preferred blowing agents are volatile organic compounds such as hydrocarbons, halogenated hydrocarbons, alcohols, ethers, ketones and esters. Particular preference is given to C₄-C₈-hydrocarbons, in particular butane, pentane or hexane. The blowing agents are preferably used in amounts of from 1 to 40% by weight, in particular from 5 to 25% by weight, based on the solids.

The addition of an emulsifier or an emulsifier mixture is necessary to emulsify the blowing agent and to stabilize the foam. As emulsifier, it is possible to use inorganic, cationic, nonionic or amphoteric surfactants.

Suitable anionic surfactants are diphenylene oxide sulfonates, alkanesulfonates and alkylbenzenesulfonates, alkylnaphthalenesulfonates, olefin sulfonates, alkyl ether sulfonates, alkylsulfates, alkyl ether sulfates, alpha-sulfo fatty acid esters, acylaminoalkanesulfonates, acylisethionates, alkyl ether carboxylates, N-acylsarcosinates, alkylphosphates and alkyl ether phosphates. As nonionic surfactants, it is possible to use alkylphenol polyglycol ethers, fatty alcohol polyglycol ethers, fatty acid polyglycol ethers, fatty acid alkanolamides, EO/PO block copolymers, amine oxides, fatty acid esters of glycerol, sorbitan esters and alkylpolyglucosides. As cationic surfactants, use is made of alkyltriammonium salts, alkylbenzyldimethylammonium salts and alkylpyridinium salts. The emulsifiers are preferably added in amounts of from 0.1 to 5% by weight, based on the SiO₂ particles.

The mixture to be foamed can further comprise customary additives such as pigments and fillers. To color the silicate structure, it is possible to use, for example, metal oxides, for instance oxides of iron, copper, chromium, manganese, cobalt, nickel, selenium or rare earths. To improve the thermal insulation action, it is possible to add IR absorbers and/or reflectors, e.g. cerium compounds. Boron oxides, borates, phosphates or aluminum oxides can be added to optimize the thermal, electrical or mechanical properties of the silicate framework.

To improve foamability, it is possible to add viscosity-increasing additives, e.g. starch or modified celluloses.

The foaming of the mixture obtained from step (b) can be effected in step (c) by heating to a temperature in the range from 35 to 100° C., preferably in the range from 60 to 90° C. Warming or heating can be carried out by customary methods, e.g. by means of an oven, hot air or microwaves. Preference is given to microwaves because they make particularly homogeneous and rapid warming or heating possible.

In another embodiment, the mixture is foamed by depressurization in step (c). This results in expansion of the blowing agent and a strong foam is likewise formed. Pressure reduction also encompasses the case of the mixture under a pressure P1 being depressurized through a nozzle to a pressure P2<P1, where P1 is>1 bar. In these embodiments, heating is not absolutely necessary to bring about foaming.

In step (d), the still moist foam is stabilized by treatment with a hardener. This results in strengthening and gel formation by agglomeration and condensation. Suitable hardeners are, for example, esters of organic acids, propylene carbonate, aluminates or aluminophosphates, boric acid, anhydrides, acidic gases or aerosols. The treatment is preferably carried out by passing gaseous carbon dioxide as hardener over the foam.

When aluminates are used as hardeners, the molar ratio of SiO₂:Al₂O₃ is preferably above 50:1. The foam particularly preferably consists essentially of SiO₂, with, in particular, aluminum and sodium being present in amounts of less than 5000 ppm, in particular less than 3000 ppm.

To improve the mechanical stability, the foam can be treated with a solution of alkoxysilanes before or after the stabilization in step (d).

To improve the mechanical stability, the foam is generally dried at from 100 to 140° C. after step (d) and is sintered at a temperature of above 500° C., preferably in the range 550-800° C., in a subsequent step (e).

After step (e), the elastic inorganic foam obtained can be impregnated with a size customary for glass fibers, for example silanes. This after-treatment can lead to an improvement in the mechanical stability as a result of a reduction in the notched impact susceptibility.

An after-treatment can also be used for hydrophobicizing the foam. Here, preference is given to using hydrophobic coating agents which have a high thermal stability and a low combustibility, for example silicones, siliconates or fluorinated compounds.

The process described produces foam blocks or plates which can be cut to any shapes.

The density of the foam is less than 25 kg/m³, preferably less than 20 kg/m³, particularly preferably in the range from 5 to 18 kg/m³. The silicate-based foam preferably has a molar ratio of SiO₂:Al₂O₃ of greater than 20:1 and a molar ratio of SiO₂:Me₂O of less than 50:1, where Me is an alkali metal, for example lithium, potassium, sodium, rubidium or cesium.

The foam which can be obtained by the process of the invention preferably has an open-celled structure having a proportion of open cells, measured in accordance with DIN ISO 4590, of more than 50%, in particular more than 80%.

The average pore diameter is preferably in the range from 10 to 1000 μm, in particular in the range from 50 to 500 μm.

The melting point or softening point of the foam of the invention is below 1600° C., preferably in the range from 700 to 800° C. Mechanically stabile silicate foams having a high melting point or softening point can be obtained when a colloidal, aqueous dispersion of small, solid silicon dioxide particles which have the above-described, low proportion of alkali metal is used as starting material.

The foam of the invention can be used in a variety of ways for thermal and acoustic insulation in buildings and in automobile construction, for example for thermal insulation in construction of buildings or as acoustic insulation material, e.g. in the engine chamber, in automobiles, aircraft, trains, ships, etc. Fields of application are preferably in areas which require a high thermal stability and low flammability, e.g. in pore burners. The material is also suitable for insulation in areas subjected to strong radiation which in the long term decomposes organic materials, for example in nuclear power stations.

Furthermore, the foam which can be obtained by the process of the invention is also suitable for applications in which open-celled aminoplastic foam is used, for example for flame-resistant textiles, upholstery, mattresses, filters and catalyst supports. It has a low-temperature elasticity comparable to open-celled aminoplastic foams. When used as polishing medium, it displays an increased hardness and abrasiveness for very hard surfaces.

### EXAMPLES

### Example 1

17 g of potassium hydroxide were added to 167 g of an aqueous dispersion of anionically stabilized, colloidal silicon dioxide (Levarsil® 50/50, average particle diameter: 50 nm, solids content: 50% by mass) and completely dissolved therein. 1.8 g of an anionic surfactant based on alkyl ether phosphates (deceth phosphates) were subsequently dissolved therein and 40 g of pentane were dispersed therein by intensive stirring, Heating to about 80° C. in a microwave oven gave a foam block over which gaseous carbon dioxide was passed at 25° C. Subsequent sintering at 600° C. gave a foam which had a density of 20 g/l and had a completely open-pored structure and high mechanical strength. The average pore diameter was 200 μm.

The frequency-dependent sound absorption was measured in accordance with ISO 10534-2 and the measured results are shown in Table 1.

TABLE 1
Sound absorption of the foam block from Example 1

| Frequency [Hz] | Absorption coefficient |
|---|---|
| 800 | 0.442 |
| 1000 | 0.539 |
| 1250 | 0.608 |
| 1600 | 0.715 |
| 2000 | 0.778 |
| 2500 | 0.781 |
| 3150 | 0.769 |
| 4000 | 0.782 |
| 5000 | 0.804 |

Example 2

17 g of potassium hydroxide and 4.6 g of rice starch were added to 167 g of an aqueous dispersion of colloidal silicon dioxide (average particle diameter: 50 nm, solids content: 50% by mass) and completely dissolved therein. 1.8 g of an anionic surfactant based on alkyl ether phosphates were subsequently dissolved therein and 40 g of pentane were dispersed therein by intensive stirring. Heating to about 80° C. in a microwave oven gave a foam block over which gaseous carbon dioxide was passed at 25° C. Subsequent sintering at 600° C. gave a foam which had a density of 16 g/l and had a completely open-pored structure and high mechanical strength. The pore size was 100-300 μm.

### Example 3

The foam was produced in a manner analogous to Example 1, but was stored in a 70% strength by volume solution of tetraethoxysilane in ethanol for 4 days before the sintering step. After drying, the foam which has been modified in this way was sintered at 600° C. At the same pore size, the foam had an increased mechanical strength compared to the foam from Example 1.

### Example 4

The foam from Example 1 was cut into two cubes (2*2*2 cm). One cube was steeped in an about 20% strength aqueous fluorocarbon dispersion and dried. The treated specimen was placed together with the untreated comparative specimen on the surface of water in a glass vessel. The untreated specimen sank in an instant while the other specimen floated.

1.-13. (canceled)

14. A process for producing a silicate foam, which comprises the steps:
(a) partial hydrolysis of an aqueous dispersion of SiO₂ particles which have an average particle diameter in the range from 1 to 100 nm by means of a strong base,
(b) adding a surfactant and a blowing agent and dispersion of the blowing agent at temperatures below 50° C.,
(c) foaming of the mixture by heating to a temperature in the range from 35 to 100° C. or by depressurization,
(d) stabilizing the foam obtained in step c) by means of an acidic gas or aerosol,
(e) sintering of the foam at a temperature above 500° C.

15. The process according to claim 14, wherein said strong base is sodium hydroxide, potassium hydroxide or lithium hydroxide.

16. The process according to claim 15, wherein the partially hydrolyzed aqueous dispersion in step a) has a molar ratio of SiO₂:Me₂O of less than 50:1, where Me is an alkali metal.

17. The process according to claim 14, wherein said surfactant is an alkyl ether sulfate or alkyl ether phosphate.

18. The process according to claim 14, wherein said blowing agent is a C₄-C₈-hydrocarbon.

19. The process according to claim 16, wherein said surfactant is an alkyl ether sulfate or alkyl ether phosphate and said blowing agent is a C₄-C₈-hydrocarbon.

20. The process according to claim 14, wherein starch or modified cellulose is added to the aqueous dispersion of SiO₂ particles.

21. The process according to claim 14, wherein the foam is treated with a solution of alkoxysilanes before or after step d).

22. The process according to claim 14, wherein the stabilization in step d) is effected by treatment with gaseous carbon dioxide as hardener.

23. The process according to claim 19, wherein starch or modified cellulose is added to the aqueous dispersion of SiO₂ particles.

24. The process according to claim 23, wherein the foam is treated with a solution of alkoxysilanes before or after step d).

25. The process according to claim 24, wherein the stabilization in step d) is effected by treatment with gaseous carbon dioxide as hardener.

26. A silicate foam which has a density of less than 25 kg/m³ and a proportion of open cells in accordance with DIN ISO 4589 of more than 50% and which can be obtained by the process according to claim 14.

27. The silicate foam according to claim 26, wherein the average pore diameter is in the range from 10 to 1000 μm.

28. Thermal or acoustic insulation which comprises the silicate foam according to claim 26.

29. A process for cleaning or for polishing which comprises utilizing the silicate foam according to claim 26.
